(19) United States
(12) Patent Application Publication
(10) Pub. No.: US 2021/0287263 A1
(43) Pub. Date: Sep. 16, 2021

(54) AUTOMATED CUSTOMER INTERACTION QUALITY MONITORING

(71) Applicant: GENESYS TELECOMMUNICATIONS LABORATORIES, INC., DALY CITY, CA (US)

(72) Inventors: SHAI ALON, TEL AVIV (IL); ROTEM SHEM-TOV, KFAR SABA (IL)

(73) Assignee: GENESYS TELECOMMUNICATIONS LABORATORIES, INC., DALY CITY, CA (US)

(21) Appl. No.: 17/188,282

(22) Filed: Mar. 1, 2021

Related U.S. Application Data
(60) Provisional application No. 62/987,762, filed on Mar. 10, 2020.

(51) Int. Cl. G06Q 30/02; H04M 3/51; G10L 15/26; G06F 40/35; G06Q 10/06

(52) U.S. Cl. CPC G06Q 30/0282; H04M 3/5141; H04M 3/5175; G06Q 10/06395; G06F 40/35; G06Q 30/0281; G10L 15/26

(57) ABSTRACT

A system comprising: at least one hardware processor; and a non-transitory computer-readable storage medium having stored thereon program code, the program code executable by the at least one hardware processor to: receive, by a processor, data associated with an interaction between a customer and an agent in a contact center, automatically analyze, by the processor, said data to identify one or more topics associated with a content of said interaction, automatically associate, by the processor, one or more questions from a dataset of questions with each of said identified topics, automatically construct, by the processor, a questionnaire comprising said associated questions, and output said questionnaire to said customer.

### CLAIM OF PRIORITY

This application claims the benefit of U.S. Provisional Patent Application No. 62/987,762, titled “AUTOMATED CUSTOMER INTERACTION QUALITY MONITORING”, filed in the U.S. Patent and Trademark Office on Mar. 10, 2020, the contents of which are incorporated herein.

### BACKGROUND

Contact centers are staffed with agents or employees who serve as an interface between an organization, such as a company, and outside entities, such as customers. For example, human sales agents at contact centers may assist customers in making purchasing decisions and may receive purchase orders from those customers. Similarly, human support agents at contact centers may assist customers in solving problems with products or services provided by the organization. Interactions between contact center agents and outside entities (e.g., customers) may be conducted by speech voice (e.g., telephone calls or voice over IP or VoIP calls), video (e.g., video conferencing), text (e.g., emails and text chat), or through other media.

Quality monitoring in contact centers refers to the process of evaluating agents and ensuring that the agents are providing sufficiently high quality service in assisting the customers. Generally, a quality monitoring process will monitor the performance of an agent by evaluating the interactions that the agent participated in for events such as whether the agent was polite and courteous, whether the agent was efficient, and whether the agent was knowledgeable and proposed the correct solutions to resolve a customer's issue.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising: at least one hardware processor; and a non-transitory computer-readable storage medium having stored thereon program code, the program code executable by the at least one hardware processor to: receive, by a processor, data associated with an interaction between a customer and an agent in a contact center, automatically analyze, by the processor, said data to identify one or more topics associated with a content of said interaction, automatically associate, by the processor, one or more questions from a dataset of questions with each of said identified topics, automatically construct, by the processor, a questionnaire comprising said associated questions, and output said questionnaire to said customer.

There is also provided, in an embodiment, a method comprising: receiving, by a processor, data associated with an interaction between a customer and an agent in a contact center; automatically analyzing, by the processor, said data to identify one or more topics associated with a content of said interaction; automatically associating, by the processor, one or more questions from a dataset of questions with each of said identified topics; automatically constructing, by the processor, a questionnaire comprising said associated questions; and outputting said questionnaire to said customer.

There is further provided, in an embodiment, a computer program product comprising a non-transitory computer-readable storage medium having program code embodied therewith, the program code executable by at least one hardware processor to: receive, by a processor, data associated with an interaction between a customer and an agent in a contact center; automatically analyze, by the processor, said data to identify one or more topics associated with a content of said interaction; automatically associate, by the processor, one or more questions from a dataset of questions with each of said identified topics; automatically construct, by the processor, a questionnaire comprising said associated questions; and output said questionnaire to said customer.

In some embodiments, the associating of the one or more questions with each of said identified topics comprises, for each topic of the plurality of tracked topics: (i) computing a question-topic similarity metric between the text of the question and the topic; and (ii) associating the topic to the question when the question-topic similarity metric exceeds a threshold.

In some embodiments, the questions are selected from the group consisting of: yes/no questions, multiple response questions, numerical value questions, and free text questions.

In some embodiments, the computing of the question-topic similarity metric between the text of the question and the topic comprises: (i) computing a plurality of word similarity metrics, each word similarity metric corresponding to a similarity between a word of the text of the question and a most similar word in the topic; and (ii) summing the plurality of word similarity metrics to compute the question-topic similarity metric.

In some embodiments, the interaction is at least one of: a textual interaction and a verbal interaction.

In some embodiments, the analyzing comprises at least one analysis selected from the group consisting of: textual detection, speech detection, speech-to-text detection, sentiment detection analysis, and emotion detection.

In some embodiments, the analyzing further comprises arranging said identified topics in a hierarchy of topics, and wherein said constructing further comprises arranging said associated questions based, at least in part, on said hierarchy.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a schematic block diagram of an exemplary system 100 for automated quality evaluation in the context of a contact center interaction, according to an embodiment;

FIG. 2 is a flowchart of the functional steps in automatically generating a list of topics associated with a contact center interaction, according to an embodiment; and

FIGS. 3 and 4 are flowcharts of the functional steps in automatically generating a personalized customer survey questionnaire in conjunction with a contact center interaction, according to an embodiment.

### DETAILED DESCRIPTION

Disclosed herein are a method, system, and computer program product for automated quality evaluation in the context of a contact center interaction.

In some embodiments, the interaction is between, e.g., a customer and one or more contact center agents. In some embodiments, the evaluation is based on feedback garnered from the customer involved in the interaction. In some embodiments, the evaluation is based on an automatically-generated personalized set of questions presented to the customer in conjunction with the interaction.

As used herein in connection with embodiments of the present invention, the term “customer” denotes a party external to the contact center irrespective of whether or not that party is a “customer” in the sense of having a commercial relationship with the contact center or with a business represented by the contact center. “Customer” is thus shorthand, as used in contact center terminology, for the other party to a contact or a communications session.

Garnering feedback from a customer when they call into a contact center is a challenge. The most common method of gauging customer satisfaction is to transfer the call to a post-call survey questionnaire or form, once the agent has dropped off, in which the customer goes through a series of voice menus and rates their experience. Most customers ignore such surveys, to the point where companies often offer an incentive for those customers who stay on the line. However, the vast majority of customers still will not participate because answering a generic surveys is perceived as an inconvenience with little or no benefit to the customer. In other words, when a customer does go to the trouble of providing their opinions, for example to convey how especially helpful and informed the agent had been, the feedback or effect of the feedback generally is not reflected publicly for the customer or others to view and use.

Accordingly, in some embodiments, the present disclosure provides for automated personalized survey questionnaire design and generation, to ensure that the form is more focused, relevant to the experience of the customer, and not unnecessarily burdensome. In some embodiments, the present disclosure provides for automated generation of a personalized survey questionnaire configured to assess a quality of a contact center interaction, wherein the survey questionnaire is generated based, at least in part, on an analysis of a content of the interaction.

In some embodiments, the present disclosure provides for automatically extracting, by a processor, a set of features from the interaction, wherein the set of features comprises at least some of content, topics, words, terms, phrases, speech, text, tone, speaker sentiments, and speaker emotion as automatically detected in the interaction.

In some embodiments, the present disclosure further provides for obtaining additional information concerning the interaction, including, but not limited to, an identity of parties to the interaction; information regarding similar and/or related interactions involving the same customer; identities of contact center agents involved in similar and/or related interactions involving the customer, and the like.

In some embodiments, the present disclosure then provides for automatically generating a personalized survey questionnaire based, at least in part, on the extracted features and/or information.

In some embodiments, a survey questionnaire may be generated as part of a quality monitoring (QM) process. In the context of a contact center, QM refers to the process of evaluating contact center agents to measure and ensure the quality of the service provided by the agents. Typically, quality monitoring is performed to measure agent performance during interactions (e.g., calls, text chats, and email exchanges) between the agents and customers, on such metrics as politeness, demeanor, efficiency, and/or effectiveness.

A QM evaluation may be triggered by an evaluator or a supervisor of the contact center, who is charged with evaluating an agent's performance. For example, a supervisor may listen in on an interaction, to provide a qualitative assessment and performance feedback. However, such a process does not reflect feedback from the customer side regarding customer experience and perspective. Accordingly, in some embodiments, the present disclosure provides for initiating a customer feedback process to include customer experience and perspective in the QM process.

In some embodiments, the present disclosure may provide for automating portions of a QM process in a contact center. Accordingly, an automated personalized survey questionnaire generation process may generate a survey questionnaire may be used to solicit or garner customer feedback. Such customer feedback may in turn be used in conjunction with a QM evaluation of an agent's performance during an interaction that the agent participated in. in some embodiments, the survey questionnaire may include one or more questions (e.g., “was the agent attentive” or “was the agent courteous”). In some embodiments, the questionnaire may also include various question types, e.g., yes/no questions, multiple choice questions, numerical value questions (e.g., on a scale from 1 to 5), or free-form questions.

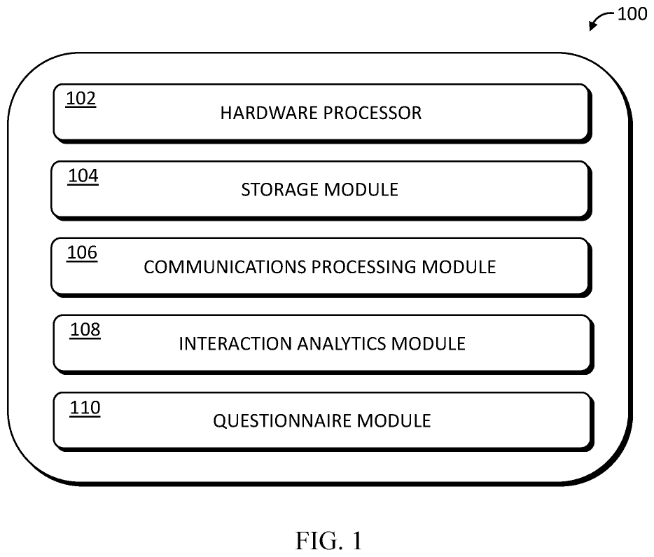

FIG. 1 is a schematic block diagram of an exemplary system 100 for automated quality evaluation in the context of a contact center interaction, according to some embodiments of the present disclosure. System 100 as described herein is only an exemplary embodiment of the present invention, and in practice may have more or fewer components than shown, may combine two or more of the components, or a may have a different configuration or arrangement of the components. The various components of system 100 may be implemented in hardware, software or a combination of both hardware and software. In various embodiments, system 100 may comprise a dedicated hardware device, or may form an addition to/or extension of an existing device.

System 100 may store in storage module 104 software instructions or components configured to operate a hardware processor 102 comprising such as hardware processor (also “hardware processor,” “CPU,” or simply “processor”). In some embodiments, the software components may include an operating system, including various software components and/or drivers for controlling and managing general system tasks (e.g., memory management, storage device control, power management, etc.) and facilitating communication between various hardware and software components.

In some embodiments, storage module 104 may store recorded interactions between customers and agents at a contact center, as well as other data pertaining thereto. In some embodiments, storage module 104 may store one or more databases relating to agent data (e.g. agent profiles, schedules, etc.), customer data (e.g. customer profiles, attributes, history, etc.), interaction data (e.g. details of each interaction with a customer, including reason for the interaction, disposition data, time on hold, handle time, etc.), and the like. According to some embodiments, some of the data (e.g. customer profile data) may be maintained in a customer relations management (CRM) database hosted in storage module 104 or elsewhere.

In some embodiments, the contact center may be a customer service help desk, emergency response, telemarketing, order taking, and the like. In some embodiments, the contact center may be an in-house facility at a business or corporation for serving the sales and service needs of the enterprise, or a third-party service provider. In some embodiments, the contact center may be deployed in a remote computing environment. The various components of the contact center system may also be distributed across various geographic locations and computing environments and not necessarily contained in a single location, computing environment, or device. Customers may initiate inbound telephony calls to the contact center via end user devices, such as, for example, a telephone, wireless phone, smartphone, personal computer, electronic tablet, and/or the like. Interactions may be conducted over one or more of telephone calls, emails, chats, text messaging, web-browsing sessions, and other multi-media transactions. Similarly, interactions may use one or more of a telephone, cellular, wireless carrier network, and/or data communication network, e.g., a private or public switched telephone network (PSTN), local area network (LAN), private wide area network (WAN), and/or the Internet.

In some embodiments, the contact center includes one or more facilities for receiving customer communications, e.g., a communications network for receiving and transmitting customer communications over a wide variety of networks and communications means. in some embodiments, the contact center has internal routing facilities configured to route interactions to agents.

In some embodiments, communications processing module 106 may be configured to process customer interactions, e.g., PSTN calls, VoIP calls, and the like. For example, communications processing module 106 may extract data about the customer interaction, such as automatic number identification (ANI) number, the customer's internet protocol (IP) address, and/or email address. In some embodiments, communications processing module 106 may communicate with a customer database, which stores information such as contact information, service level agreement (SLA) requirements, nature of previous customer contacts, actions taken by contact center to resolve any customer issues, and the like.

In some embodiments, the recorded calls may be processed by interaction analytics module 108 analyze and/or recognize interaction content. For example, interaction analytics module 108 may generate recognized text and/or recognized speech, e.g., within a speech-to-text transcript of a voice interaction. In some embodiments, interaction analytics module 108 is further configured to perform analytics on recognized speech data such as by detecting events occurring in the interactions and categorizing the interactions in accordance with the detected events. In some embodiments, interaction analytics module 108 may operate during a voice interaction between a customer and a live human agent in order to perform analytics on the voice interactions. During a voice interaction, audio containing speech from the customer and speech from the human agent (e.g., as separate audio channels or as a combined audio channel) may be processed by interaction analytics module 108 to identify words and phrases uttered by the customer and/or the agent during the interaction. In some embodiments, a variety of speech and/or text recognition techniques may be employed by interaction analytics module 108.

In some embodiments, interaction analytics module 108 may be further configured to process customer interactions and/or recognized text and/or speech and/or any features extracted therefrom, to further perform sentiment analysis and/or emotion recognition analysis with respect thereto. Sentiment analysis, also referred to as “opinion mining” or “emotion AI,” is a method by which tools such as natural language processing (NLP), text analysis, computational linguistics, and machine learning, are used to determine opinions and feelings from a text. Sentiment analysis is typically applied to on-line ratings, social media posts, and other similar situations. Emotion recognition the process of identifying human emotion using one or more of speech content and/or textual content.

In some embodiments, interaction analytics module 108 is configured to analyze voice or non-voice interactions with real customers of the contact center for learning dialog patterns and correlation with contact center goals such as, for example, first call resolution, customer satisfaction, compliance with guidelines, policies, and procedures, and the like. For example, a dialog tree or sequence for modeling a successful first call resolution for a particular topic may be learned and maintained. An actual interaction dialog sequence may then be compared to the modeled dialog sequence for determining any diversions, wherein such diversions may be indicative of a quality assessment of the interaction.

In some embodiments, interaction analytics module 108 may include a voice/text analytics module configured to perform analytics of responses from an agent during an interaction with the customer, for developing a semantic understanding on an interaction. Accordingly, interaction analytics module 108 may determine whether responses by the agents match expected responses for assessing agent performances during the interactions. In some embodiments, interaction analytics module 108 may be configured to automatically learning a set of topics reflected in interactions, wherein a “topic” may refer to a concept or event that occurred in an interaction. A topic may be learned or constructed from speech and/or textual analysis of interactions. For example, a topic termed “billing” may be assigned to an interaction which includes phrases such as “invoice,” “payment,” etc. Accordingly, detecting any of the phrases within an interaction can identify the section containing the phrases as relating to the associated topic.

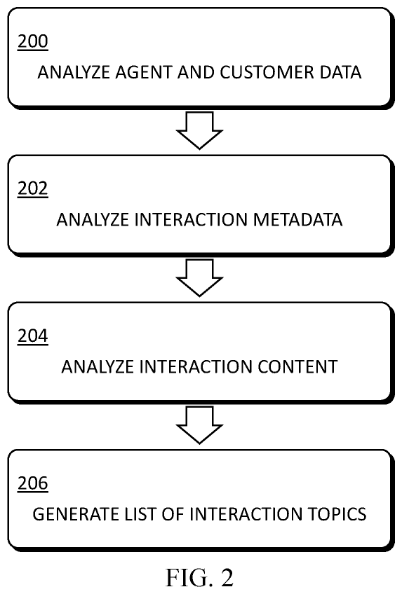

FIG. 2 is a flowchart of the functional steps in automatically generating a list of topics associated with a contact center interaction, according to an embodiment.

In some embodiments, at step 200, interaction analytics module 108 may analyze agent and/or customer data stored in storage module 104, such as identify and profiles of one or more agents, relevant history of one or more agents, and/or customer profile and history. In some embodiments, customer data may comprise a plurality of attributes, such as gender, age, geographic location, marital status, and education level.

In some embodiments, at step 202, interaction analytics module 108 may analyze interaction data, such as interaction time and date, details of previous interactions with the customer, reason for the interaction, overall theme of the interaction (e.g., billing, customer service, technical support, etc.), interaction disposition data, interaction length, time on hold, handle time, etc.

In some embodiments, at step 204, interaction analytics module 108 may further analyze and/or recognize interaction content, based, e.g., on speech recognition, text recognition, sentiment analysis, emotion analysis, and the like.

In some embodiments, at step 206, interaction analytics module 108 may then generate a list of topics involved in the interaction. In some embodiments, topics can be grouped together into groups and subgroups, and/or overarching themes and topics. In some embodiments, topics may be arranged to form a semantic hierarchy or taxonomy of groups and topics. In some embodiments, topics may relate to interaction content, e.g., “billing” or “service call.” In some embodiments, topics may reflect points of interest in a contact center interaction flow, e.g., customer complaint, customer request for escalation, customer request for a callback, etc. In some embodiments, topics may reflect a sentiment, emotion, and/or mood of interaction participants, e.g., “angry,” “negative,” “enthusiastic,” etc. In some embodiments, topics may reflect a conduct, demeanor, or manner of interaction participants, e.g., courteousness, politeness, rudeness, use of profanity, laughter, or raising of voice. In some embodiments, topics may reflect a focus and/or emphasis taken in the interaction, for example, a specific service or product, a company, a business, a category, etc. In some embodiments, topics may refer to an interaction as a whole, and/or to one or more identified portions of the interaction.

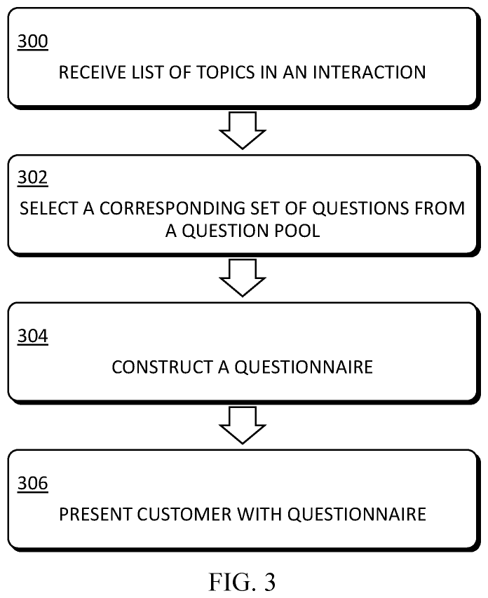

FIG. 3 is a flowchart of the functional steps in automatically generating a personalized customer survey questionnaire in conjunction with a contact center interaction, according to an embodiment.

In some embodiments, at step 300, questionnaire module 110 receives a list of topics identified and generated by interaction analytics module 108, based on an analysis of the interaction as detailed with reference to FIG. 2.

In some embodiments, at step 302, questionnaire module 110 searches a provided dataset of questions to match one or more corresponding questions with at least some of the topics identified in the list of topics. In some embodiments, the dataset of questions may be provided based, e.g., on questions authored and/or developed by specialists within the contact center.

In some embodiments, questionnaire module 110 may match questions with topics based, e.g., on an assigned metric assessing the relevance of a score to the interaction topic. For example, a question relating to agent demeanor may assigned different scores based on a number and/or occurrence frequency of topics and/or subtopics associated with agent conduct and manner, and/or based on an analysis of the frequency with which the agent uses polite phrasing in the interaction.

A question may also be assigned a relevance metric based on a place of an associated topic in a hierarchy of topics in the interaction. For example, a question concerning a product quality and/or value assessment of a product may be assigned a higher relevance when a topic associated with product warranty is placed higher in the hierarchy or topics.

In some embodiments, the questionnaire module 110 may determine a subset of questions selected from the dataset based, at least in part, on a relevancy assessment score and/or related assessment. In some embodiments, the selected subset may be constructed into a survey questionnaire. In some embodiments, an order of the questions within a questionnaire may be determined based on a plurality of factors, e.g., question relevance, topic importance, topic hierarchy, etc.

In some embodiments, the relevance of questions may be determined based on an analysis of one or more other interactions, e.g., to determine a number (or a percentage) of interactions that include a similar topic. For example, if that number or percentage is below a certain threshold, then the question may have limited relevance to most customers and therefore may be deemed to be potentially unnecessarily burdensome to answer. In some embodiments, relevance may refer, for example, to a topic which comes up in very few interactions, and/or a topic whose associated question(s) may typically be answered in a similar fashion. In some embodiments, questions may be selected when a topic identified in an interaction correlates with one or more other topics.

In some embodiments of the present invention, relevance and relationships between questions and topics may be manually specified by an author and/or developer of evaluation questions. In some embodiments of the present invention, machine learning techniques may be used to automatically infer relationships between a supplied question and one or more defined topics.

In some embodiments, at step 304, the generated questionnaire may be present to the customer.

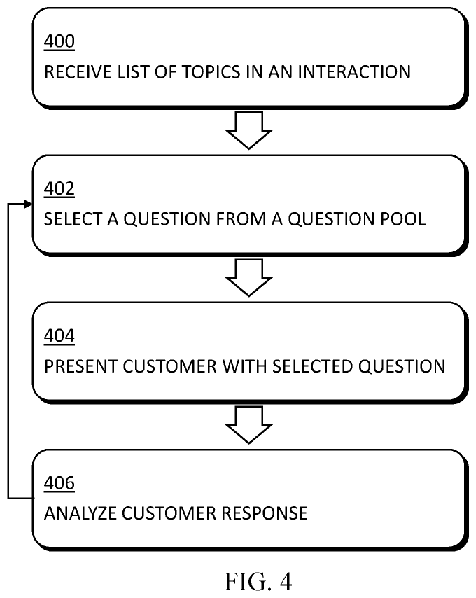

FIG. 4 illustrates a survey questionnaire construction method, in accordance with some embodiments. In FIG. 4, a survey questionnaire may be constructed dynamically, based on real time analysis of answers and/or identification of topics. Accordingly, the method illustrated in FIG. 4 may generate a dynamic survey tree and/or path, where a survey of questions may be dynamically constructed based on dynamic real-time analysis of responses, attributes information, and/or topics. Accordingly, at step 402, a next may be added and/or selected to the construction of the survey, based, at least in part, on dynamic real-time analysis of responses, attributes information, and/or topics. In some embodiments, if no new and/or relevant information is garnered from previous responses, the system may determine to either present a default set of questions or no questions and move on to the next branch of the tree. For example, questions may be presented according to a dynamically adjustable question tree, whereby subsequent questions that are presented to the contacting customer depend on selections from previous questions. For example, if a customer is contacting a contact center to request support for a particular product, the customer may be first prompted to indicate, e.g., a model of the product. By using directed questions and sequentially filtering subsequent questions based on previously submitted user-input, characteristics of the contacting customer's computing environment can be ascertained.

In some aspects of embodiments of the present invention, a questions dataset may comprise a table of connection to topics. In some embodiments, an author and/or developer may generate manual connections between topics and questions, for example, based on a running list of topics tracked by the system. For example, for a question such as: “Did the agent take ownership of the problem?,” the developer may manually select the topic “Assume Ownership” from the list of topics, wherein an interaction tagged with the “Assume Ownership” topic indicates that the agent spoke one of the phrases contained in the “Assume Ownership” topic, such as “I can solve your problem,” or “I can take care of that for you”). The selected topic can then be associated with the question (e.g., by storing, in a database of evaluation forms, the topic as one of the question topics associated with the question).

In some embodiments, inferring relationships between questions and topics may be done automatically. In some embodiments, machine learning techniques such as semantic similarity may be used in the process of inferring topics based on the text of the questions. In some embodiments, the system analyzes the text of the question and automatically identifies a semantic similarity between the question and existing topics, identify one or more tracked topics that are similar to the question. For example, the topic “Greeting” may relate to the phrases: “how can I help you,” “how can I help you today,” “how may I help you,” and “how may I help you today.” The semantic similarity between the words “how can I assist” in the question and the “Greeting” topic may be determined even when the word “assist” does not appear in any of the phrases in the “Greeting” topic, through the use of semantic similarity.

In some embodiments, to identify tracked topics that are relevant to questions, question and tracked topics may be represented using a vector. Thus, similarity may be based on detecting a word or phrase similarity based on the vector representations, wherein a similarity between a question and a topic is the sum of the similarities of the individual words herein. If the resulting sum exceeds a threshold value, then it is inferred that there is a connection between the question and the topic. However, embodiments of the present invention are not limited to the above and alternative techniques for computing similarities between questions and topics may be used (e.g., alternative techniques for comparing collections of words).

Some aspects of embodiments of the present invention may also be associated with associating the answers to multiple choice questions with particular topics. For example, in a manner similar to comparing the text of the question to the various topics, the answers of a multiple choice question can be compared, in conjunction with the question text, to the topics in order to identify which topics distinguish those answers from the other answers. In other words, because both the question and the answer correlate in the interaction document, each answer is unified with the question to form a separate question and answer combination, and the resulting combination is compared to the topics to identify a most similar topic.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of a numerical range should be considered to have specifically disclosed all the possible subranges as well as individual numerical values within that range. For example, description of a range from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Experiments conducted and described above demonstrate the usability and efficacy of embodiments of the invention. Some embodiments of the invention may be configured based on certain experimental methods and/or experimental results; therefore, the following experimental methods and/or experimental results are to be regarded as embodiments of the present invention.

What is claimed is:

1. A system comprising:
at least one hardware processor; and
a non-transitory computer-readable storage medium having stored thereon program code, the program code executable by the at least one hardware processor to:
receive, by a processor, data associated with an interaction between a customer and an agent in a contact center,
automatically analyze, by the processor, said data to identify one or more topics associated with a content of said interaction,
automatically associate, by the processor, one or more questions from a dataset of questions with each of said identified topics,
automatically construct, by the processor, a questionnaire comprising said associated questions, and
output said questionnaire to said customer.

2. The system of claim 1, wherein the associating of the one or more questions with each of said identified topics comprises, for each topic of the plurality of tracked topics:
(i) computing a question-topic similarity metric between the text of the question and the topic; and
(ii) associating the topic to the question when the question-topic similarity metric exceeds a threshold.

3. The system of claim 2, wherein said questions are selected from the group consisting of: yes/no questions, multiple response questions, numerical value questions, and free text questions.

4. The system of claim 2, wherein the computing of the question-topic similarity metric between the text of the question and the topic comprises:
(i) computing a plurality of word similarity metrics, each word similarity metric corresponding to a similarity between a word of the text of the question and a most similar word in the topic; and
(ii) summing the plurality of word similarity metrics to compute the question-topic similarity metric.

5. The system of claim 1, wherein said interaction is at least one of: a textual interaction and a verbal interaction.

6. The system of claim 1, wherein said analyzing comprises at least one analysis selected from the group consisting of: textual detection, speech detection, speech-to-text detection, sentiment detection analysis, and emotion detection.

7. The system of claim 6, wherein said analyzing further comprises arranging said identified topics in a hierarchy of topics, and wherein said constructing further comprises arranging said associated questions based, at least in part, on said hierarchy.

8. A method comprising:
receiving, by a processor, data associated with an interaction between a customer and an agent in a contact center;
automatically analyzing, by the processor, said data to identify one or more topics associated with a content of said interaction;
automatically associating, by the processor, one or more questions from a dataset of questions with each of said identified topics;
automatically constructing, by the processor, a questionnaire comprising said associated questions; and
outputting said questionnaire to said customer.

9. The method of claim 8, wherein the associating of the one or more questions with each of said identified topics comprises, for each topic of the plurality of tracked topics:
(i) computing a question-topic similarity metric between the text of the question and the topic; and
(ii) associating the topic to the question when the question-topic similarity metric exceeds a threshold.

10. The method of claim 9, wherein said questions are selected from the group consisting of: yes/no questions, multiple response questions, numerical value questions, and free text questions.

11. The method of claim 9, wherein the computing of the question-topic similarity metric between the text of the question and the topic comprises:
(i) computing a plurality of word similarity metrics, each word similarity metric corresponding to a similarity between a word of the text of the question and a most similar word in the topic; and
(ii) summing the plurality of word similarity metrics to compute the question-topic similarity metric.

12. The method claim 8, wherein said interaction is at least one of: a textual interaction and a verbal interaction.

13. The method of claim 8, wherein said analyzing comprises at least one analysis selected from the group consisting of: textual detection, speech detection, speech-to-text detection, sentiment detection analysis, and emotion detection.

14. The method of claim 13, wherein said analyzing further comprises arranging said identified topics in a hierarchy of topics, and wherein said constructing further comprises arranging said associated questions based, at least in part, on said hierarchy.

15. A computer program product comprising a non-transitory computer-readable storage medium having program code embodied therewith, the program code executable by at least one hardware processor to:
receive, by a processor, data associated with an interaction between a customer and an agent in a contact center;
automatically analyze, by the processor, said data to identify one or more topics associated with a content of said interaction;
automatically associate, by the processor, one or more questions from a dataset of questions with each of said identified topics;
automatically construct, by the processor, a questionnaire comprising said associated questions; and
output said questionnaire to said customer.

16. The computer program product of claim 15, wherein the associating of the one or more questions with each of said identified topics comprises, for each topic of the plurality of tracked topics:
(i) computing a question-topic similarity metric between the text of the question and the topic; and
(ii) associating the topic to the question when the question-topic similarity metric exceeds a threshold.

17. The computer program product of claim 16, wherein said questions are selected from the group consisting of: yes/no questions, multiple response questions, numerical value questions, and free text questions.

18. The computer program product of claim 16, wherein the computing of the question-topic similarity metric between the text of the question and the topic comprises:
(i) computing a plurality of word similarity metrics, each word similarity metric corresponding to a similarity between a word of the text of the question and a most similar word in the topic; and
(ii) summing the plurality of word similarity metrics to compute the question-topic similarity metric.

19. The computer program product claim 15, wherein said interaction is at least one of: a textual interaction and a verbal interaction.

20. The computer program product of claim 15, wherein said analyzing comprises at least one analysis selected from the group consisting of: textual detection, speech detection, speech-to-text detection, sentiment detection analysis, and emotion detection.

21. The computer program product of claim 20, wherein said analyzing further comprises arranging said identified topics in a hierarchy of topics, and wherein said constructing further comprises arranging said associated questions based, at least in part, on said hierarchy.
